(19) United States
(12) Patent Application Publication
(10) Pub. No.: US 2020/0037001 A1
(43) Pub. Date: Jan. 30, 2020

(54) METHOD AND APPARATUS FOR GENERATING A COMPOSITE VIDEO STREAM FROM A PLURALITY OF VIDEO SEGMENTS

(71) Applicant: Canon Europe N.V., Amstelveen (NL)

(72) Inventors: Preben H NIELSEN, Brondby (DK); John MADSEN, Brondby (DK); Klaus KLAUSEN, Brondby (DK)

(21) Appl. No.: 15/735,841

(22) PCT Filed: May 4, 2017
(86) PCT No.: PCT/EP2017/060625

§ 371 Date: Dec. 12, 2017

(30) Foreign Application Priority Data
May 4, 2016 (GB) 1607823.0

(51) Int. Cl. H04N 19/61; H04N 21/234; H04N 19/172; H04N 21/44; H04N 19/159; H04N 19/107

(52) U.S. Cl. CPC H04N 19/61; H04N 21/23424; H04N 19/107; H04N 21/44016; H04N 19/159; H04N 19/172

(57) ABSTRACT

The invention relates to a method and a device for generating a composite video. The method comprises obtaining primary and secondary video segments each comprising a sequence of intra-coded I frames and predicted P frames, the primary and secondary video segments having first and second priority levels and first and second capture time intervals, wherein the second priority level is higher than the first priority level and the second capture time interval overlaps with the first capture time interval. The method comprises time-aligning the primary and the secondary video segments; identifying a start merge time in the primary video segment of a first anchor I frame of the secondary video segment; and merging frames of the primary and secondary video segments, without transcoding, to generate a composite video, wherein the composite video comprises frames of the primary video segment up to the start merge time, the first anchor I frame and frames of the secondary video segment subsequent to the first anchor I frame.

### BACKGROUND OF THE INVENTION

The invention relates to video editing, and more particularly to generating a composite video stream from a plurality of compressed video segments without transcoding, wherein the video segments overlap in time.

There are applications for which there is a need to merge video segments sharing a same capture time in a single video while respecting timings of the merged segments. This is the case for example when video segments of a given view of a scene are encoded with different qualities or when the segments concern different views of a same scene and there is a desire to process seamlessly all those different segments as a single video stream.

Decoding (decompressing) the video segments prior to their merge is costly in terms of resources and still does not solve the timing issues that arise as the video segments share a same capture time.

What is needed is therefore a way of generating a composite video from a plurality of compressed videos that is cost effective in terms of resources and that respects the timings of the plurality of videos.

### BRIEF SUMMARY OF THE INVENTION

According to a first aspect of the present invention there is provided a method of generating a composite video stream according to claim 1.

According to a second aspect of the present invention there is provided an apparatus for generating a composite video stream according to claim 10.

Another aspect of the invention relates to a non-transitory computer-readable medium storing a program which, when executed by a processing unit of a device in a surveillance and/or monitoring system, causes the device to perform the method defined above.

The non-transitory computer-readable medium and the device defined above may have features and advantages that are analogous to those set out in relation to the methods defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the present invention will now be described, by way of example only, with reference to the accompanying drawings in which:

FIG. 1 illustrates an example of a surveillance system;

FIG. 2 illustrates a hardware configuration of a computer device adapted to embody embodiments of the invention;

FIG. 3 depicts the generation of a composite video by merging frames of a primary video and a secondary video, according to an exemplary embodiment;

FIG. 4 is a flowchart representing a method of generating a composite video according to an embodiment of the invention; and

FIG. 5 illustrates an implementation example of the generation of a composite video in the case of a plurality of video segments.

### DETAILED DESCRIPTION OF THE INVENTION

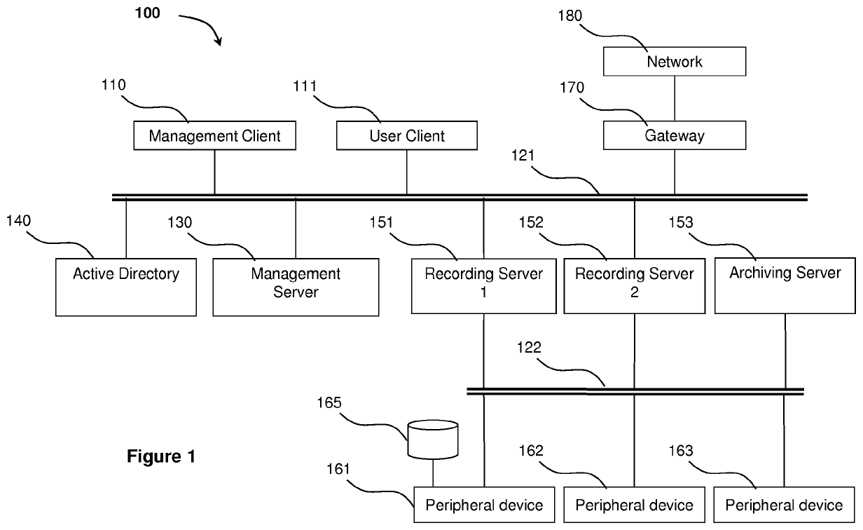

FIG. 1 shows an example of a surveillance/monitoring system 100 in which embodiments of the invention can be implemented. The system 100 comprises a management server 130, two recording servers 151-152, an archiving server 153 and peripheral devices 161-163.

Peripheral devices 161-163 represent source devices capable of feeding the system with data streams. Typically, a peripheral device is a video camera (e.g. IP camera, PTZ camera, analog camera connected via a video encoder). A peripheral device may also be of any other type such as an audio device, a detector, etc.

The recording servers are provided to store data streams (recordings) generated by peripheral devices such as video streams captured by video cameras. A recording server may comprise a storage unit and a database attached to the recording server. The database attached to the recording server may be a local database located in the same computer device than the recording server, or a database located in a remote device accessible to the recording server.

A storage unit 165, referred to as local storage or edge storage, may also be associated with a peripheral device 161 for locally storing data streams, such as a video, generated by the peripheral device. The edge storage has generally lower capacity than the storage unit of a recording server, but may serve for storing a high quality version of last captured data sequence while a lower quality version is streamed to the recording server.

A data stream may be segmented into data segments for the data stream to be stored in or read from a storage unit of a recording server. The segments may be of any size. A segment may be identified by a time interval [ts1, ts2] where ts1 corresponds to a timestamp of the segment start and ts2 corresponds to a timestamp of the segment end. The timestamp may correspond to the capture time by the peripheral device or to the recording time in a first recording server. The segment may also be identified by any other suitable segment identifier such as a sequence number, a track number or a filename.

The management server 130 stores information regarding the configuration of the surveillance/monitoring system 100 such as conditions for alarms, details of attached peripheral devices (hardware), which data streams are recorded in which recording server, etc.

A management client 110 is provided for use by an administrator for configuring the surveillance/monitoring system 100. The management client 110 displays an interface for interacting with the management software on the management server in order to configure the system, for example for adding a new peripheral device (hardware) or moving a peripheral device from one recording server to another. The interface displayed at the management client 110 allows also to interact with the management server 130 for controlling what data should be input and output via a gateway 170 to an external network 180.

A user client 111 is provided for use by a security guard or other user in order to monitor or review the output of peripheral devices 161-163. The user client 111 displays an interface for interacting with the management software on the management server in order to view images/recordings from the peripheral devices 161-163 or to view video footage stored in the recording servers 151-152.

The archiving server 153 is used for archiving older data stored in the recording servers 151-152, which does not need to be immediately accessible from the recording servers 151-152, but which it is not desired to be deleted permanently.

Other servers may also be present in the system 100. For example, a fail-over recording server (not illustrated) may be provided in case a main recording server fails. Also, a mobile server (not illustrated) may be provided to allow access to the surveillance/monitoring system from mobile devices, such as a mobile phone hosting a mobile client or a laptop accessing the system from a browser using a web client.

Management client 110 and user client 111 are configured to communicate via a network/bus 121 with the management server 130, an active directory server 140, a plurality of recording and archiving servers 151-153, and a plurality of peripheral devices 161-163. The recording and archiving servers 151-153 communicate with the peripheral devices 161-163 via a network/bus 122. The surveillance/monitoring system 100 can input and output data via a gateway 170 to an external network 180.

The active directory server 140 is an authentication server that controls user log-in and access, for example from management client 110 or user client 111, to the surveillance/monitoring system 100.

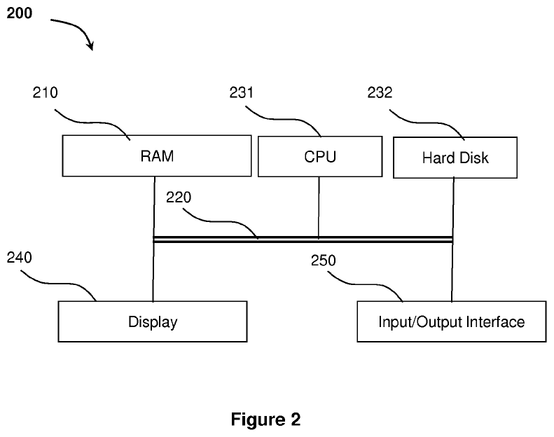

FIG. 2 shows a typical arrangement for a device 200, configured to implement at least one embodiment of the present invention. The device 200 comprises a communication bus 220 to which there are preferably connected:
a central processing unit 231, such as a microprocessor, denoted CPU;
a random access memory 210, denoted RAM, for storing the executable code of methods according to embodiments of the invention as well as the registers adapted to record variables and parameters necessary for implementing methods according to embodiments of the invention; and
an input/output interface 250 configured so that the device 200 can communicate with other devices.

Optionally, the device 200 may also include a data storage means 232 such as a hard disk for storing data and a display 240.

The executable code loaded into the RAM 210 and executed by the CPU 231 may be stored either in read only memory (not illustrated), on the hard disk 232 or on a removable digital medium (not illustrated).

The display 240 is used to convey information to the user typically via a user interface. The input/output port 250 allows a user to give instructions to the device 200 using a mouse and a keyboard, receives data from other devices, and transmits data via the network.

The clients 110-111, the management server 130, the active directory 140, the recording servers 151-152 and the archiving server 153 have a system architecture consistent with the device 200 shown in FIG. 2. The description of FIG. 2 is greatly simplified and any suitable computer or processing device architecture may be used.

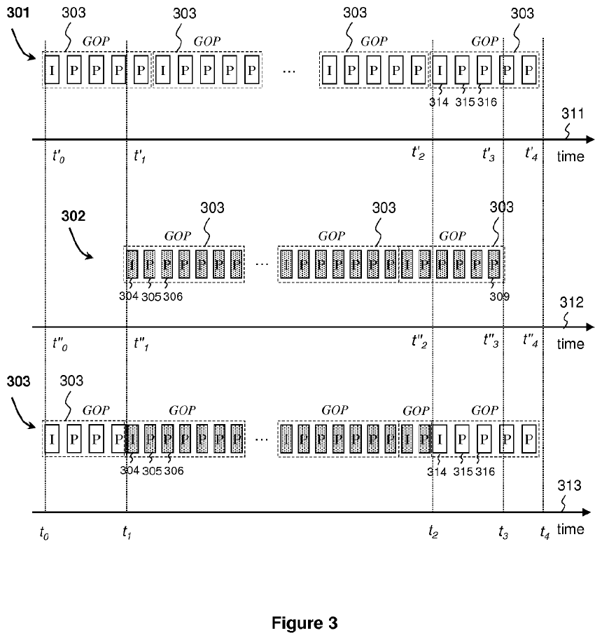

FIG. 3 depicts the generation, at a given device, of a composite video 303 by merging frames of a primary video 301 and a secondary video 302, according to an exemplary embodiment.

For illustration, we consider the surveillance/monitoring system 100 of FIG. 1 in which we assume that peripheral device 161 is a camera that is configured to capture a video, encode the captured video by means of a video encoder implementing motion compensation, i.e. exploiting the temporal redundancy in a video, and deliver two compressed videos with different compression levels, e.g. highly-compressed (lower quality) and less-compressed (higher quality) videos.

Note that embodiments of the inventions similarly apply if more than two compressed videos are delivered by the encoder, either with different compression levels (different coding rates) or with a same compression level but with different encoding parameters (frame rate, spatial resolution of frames, etc.). Embodiments of the invention also apply in case of a plurality of compressed videos encoded by different encoders and/or covering different scenes or views.

Video encoder using motion compensation may implement for example one of the MPEG standards (MPEG-1, H.262/MPEG-2, H.263, H.264/MPEG-4 AVC or H.265/HEVC). The compressed videos thus comprising a sequence of intra-coded I frames (pictures that are coded independently of all other pictures) and predicted P frames (pictures that contain motion-compensated difference information relative to previously decoded pictures). The frames are grouped into GOPs (Group Of Pictures) 303. An I frame indicates the beginning of a GOP.

In one implementation, the device implementing the generating method (given device) is within the surveillance/monitoring system 100 such as the management server 130 and has the architecture of computer device 200.

According to the exemplary embodiment, camera 161 streams the highly-compressed video to the surveillance/monitoring system to be stored at a recording server 151 for further processing, and stores the less-compressed video in its local storage 165 for later retrieval if necessary. Primary video 301 may correspond to the highly-compressed video and can thus be obtained from recording server 151. Secondary video 302 may correspond to the less-compressed video, or part of it, and can be obtained from edge storage 165 of camera 161.

Typically, primary video 301 is received as a RTP/RTSP stream from the camera 161. This protocol will deliver a timestamp together with the first frame sent and then delta (offset) times for the following frames. This allows to define the timeline of the primary video illustrated in the figure by the reference 311. In order to associate the timeline of the primary video 301 with the timeline 312 of the secondary video 302, the local time of the surveillance/monitoring system is chosen as a common time reference (absolute timeline 313). To ease the association, the timeline of the primary video 301 is converted to the absolute timeline on the fly while video frames are received. For example, when a first frame of primary video 301 is received, it is timestamped with the local time of the surveillance/monitoring system and then the delta values are added as frames are received. The frames are then stored preferably into segments (recordings) of a given duration [t₀, t₄] in the storage unit of the recording server 151, and associated metadata including the calculated timestamps are stored in the database attached to the recording server 151. Here times t₀ and t₄ are given according to the absolute timeline 313. Corresponding times t′₀ and t′₄ according to the timeline 311 extracted from the received primary video are depicted in FIG. 3 for illustration.

Secondary video 302 is received for example upon request of the given device. In one implementation, time at camera 161 is synchronized with the local time at the surveillance/monitoring system (e.g. using ONVIF commands). This allows the timeline of the video stored in the edge storage to be already expressed according to the absolute timeline 313, i.e. timelines 312 and 313 are synchronized. This way, the given device can simply send a request for a time interval [t₁, t₃], which is thus the same as [t″₁, t″₃], to the camera 161 to retrieve the sequence of frames of the secondary video 302 for that time interval, timestamped according to the absolute timeline 313.

Alternate implementations are possible for aligning the primary and the second videos and thus for associating their corresponding timelines. For example, an alignment can be done for a first timestamp t′a in the primary video with a second timestamp t″a in the secondary video (time-shift determination). Then for any time b>a, the timeline 312 for secondary video can be interpolated from the primary video: t″b=t′b+(t″a−t′a). Any suitable change in timescale has to be applied to each timestamp value before direct comparison.

One motivation to retrieve a specific time interval [t₁, t₃] from the less-compressed video is to get a higher quality video around the occurrence of an event for more thorough analysis of the video by an operator for example. The remaining of the video can be kept with lower quality. The merging of the retrieved secondary video segment 302 with the primary video 301, both videos sharing a common interval of capture time, allows for a seamless decoding and display, e.g. the video decoder only has to decode only a single stream.

Invention is not limited to the above scenario and other motivations may exist for merging two or more video sequences into a single stream for seamless decoding and display. For example, if the two videos are covering different views of a scene at a same time, it may be convenient to generate a single stream embedding the different views without transcoding, each embedded video sequence focusing on the most relevant or important view at a given time.

Priority can also be assigned to one video stream relatively to another. In this case, whenever the higher priority video is available it takes precedence in the inclusion in the composite video over the lower priority video(s). Priority can be assigned to a video based on a measure of activity, e.g. motion detection, detected in that video making the composite video more likely to include video segments during which something occurred.

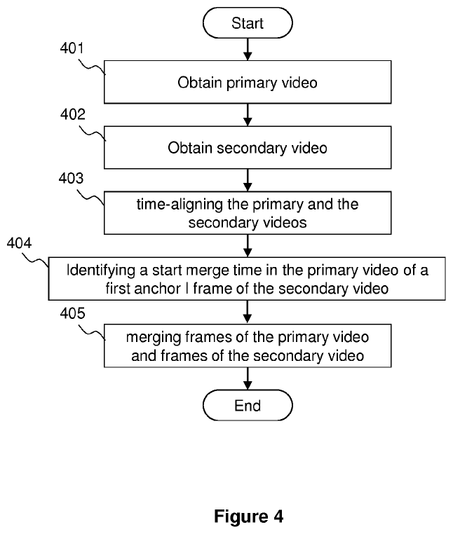

FIG. 4 is a flowchart representing a method of generating a composite video according to an embodiment of the invention. This flowchart summarizes some of the steps discussed above in relation with FIG. 3. The method is typically executed by software code executed by CPU 231 of the given device.

At steps 401 and 402, a primary video 301 and a secondary video 302 are, respectively, obtained by the device. The primary video 301 and secondary video 302 comprise a sequence of intra-coded I frames and predicted P frames generated by motion-compensated encoder implementing any suitable video encoding format.

As discussed above, according to an embodiment, the obtaining of the primary video 301 maybe performed by reading the video from the recording server 151 (time segment [t′₀, t′₄]), while the obtaining of the secondary video 302 maybe performed by receiving, upon request, the video from the edge storage 165 of camera 161 (time segment [t″₁, t″₃]). According to other embodiments, it is possible to obtain both the primary and secondary videos from a same storage unit or directly receive them from a camera.

In the example of FIG. 3, secondary video 302 is shorter than primary video 301 to illustrate a composite video which includes a switching from primary video frames to secondary video frames and then from secondary video frames back to primary video frames. Of course, the size of one video can be arbitrary relatively to the size of the other.

At step 403, the primary and the secondary videos are time-aligned by associating timelines of the two videos. Various implementations have been discussed above in relation with FIG. 3. The outcome of the alignment is that the timelines 311 and 312 can be compared. In one implementation, for example time intervals [t′₀, t′₄] and [t″₁, t″₃] can both be expressed in the common time reference 313 as [t₀, t₄] and [t₁, t₃], and thus without a need for conversion.

At step 404, a start merge time t₁ in the primary video of a first anchor I frame 304 of the secondary video is identified using the associated timelines.

Finally, at step 405, frames of the primary video 301 and frames of the secondary video 302 are merged, without transcoding, to generate a composite video 303. The composite video 303 comprises frames of the primary video up to the start merge time t₁, the first anchor I frame 304 and frames 305, 306, etc. of the secondary video subsequent to the first anchor I frame 304. Subsequent frames 305, 306, etc. may include all frames remaining in the secondary video if this latter ends prior the primary video, or only those frames in the secondary video up to a time of switching back to the primary video or to another video. In the example illustrated in FIG. 3, the first anchor I frame 304 of the secondary video 302 is the first I frame (of the first GOP) in the secondary video sequence.

In an alternate implementation (not illustrated), the first anchor I frame 304 is the I frame of the n^{th} GOP, where n 1. For example, if the size of the GOP of the primary video is much greater than the size of the GOP of the secondary video, the n^{th} GOP may be selected as the one overlapping with the beginning of a GOP in the primary video, the (n−1) previous GOPs of the secondary video are skipped, i.e. not included in the composite video.

In one implementation, an end merge time t₂ in the secondary video 302 of a second anchor I frame 314 of the primary video is identified using the associated timelines. In this case, the composite video furthermore comprises frames of the secondary video subsequent to the first anchor I frame 304 up to the end merge time t₂, the second anchor I frame 314 and frames 315, 316, etc. of the primary video 301 subsequent to the second anchor I frame 314. Subsequent frames 315, 316, etc. may include all frames remaining in the primary video till the end of the primary video, or only those frames in the primary video up to a time of switching to another video.

In the example illustrated in FIG. 3, the second anchor I frame 314 is the last I frame in the primary video sequence 301 prior to the time t₃ of the last frame 309 of the secondary video sequence 302. In an alternate implementation (not illustrated), the second anchor I frame 314 can be the I frame of an earlier GOP in the primary video.

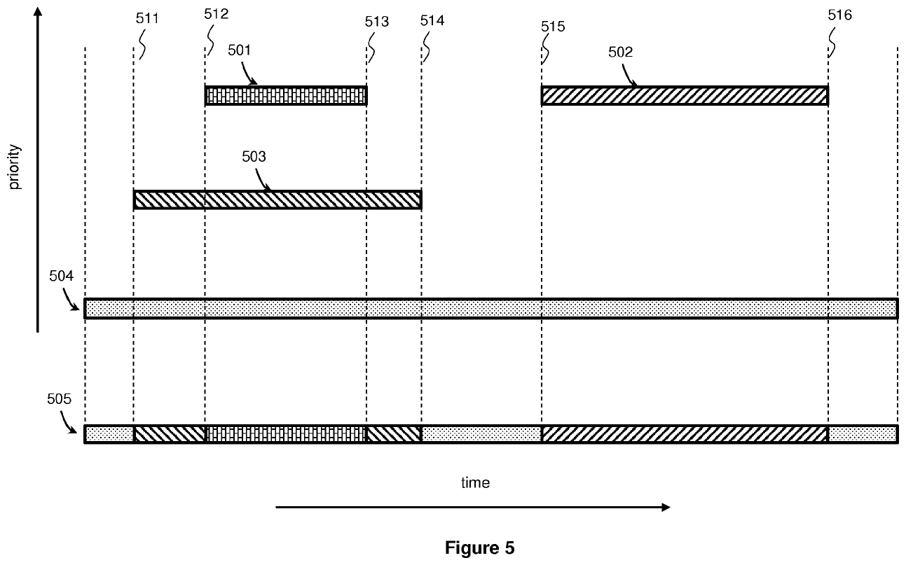

FIG. 5 illustrates an implementation example of the generation of a composite video in the case of a plurality of video segments sorted according to different priorities.

In the illustrated example, four video segments 501, 502, 503 and 504 overlap in time (share a common capture time) and have different priorities. GOP structures of the video segments are hidden for simplification. Video segments 501 and 502 have the highest and same priority. Video segment 503 has a lower priority and video segment 504 has the lowest priority. The generated composite video is represented by the numeral reference 505.

Transition (or switching) times between one video segment to another are shown at the frontier of each segment 511, 512, 513, 514, 515 and 516 to simplify the description, being understood from the description of FIG. 3 that transition times corresponding to the switching between one frame of a video to a following frame in another video may occur later that the start of a video segment and/or earlier than the end of a video segment.

The composite video 505 comprises from the start frames of video segment 504 up to the transition time 511 and then frames of the video segment 503 which is of higher priority. Here video segment 504 corresponds to the primary video 301 and video segment 503 corresponds to the secondary video 302 as discussed in relation with FIGS. 3 and 4.

The composite video 505 then comprises frames of video segment 503 up to the transition time 512 followed by frames of the video segment 501 (which is of higher priority) up to its end.

The composite video 505 then comprises, after transition time 513, remaining frames of video segment 503 up to the end of the segment 503. Here video segment 501 corresponds to the secondary video 302 and video segment 503 corresponds to the primary video 301 as discussed in relation with FIGS. 3 and 4.

The remaining construction of the composite video 505 is similar to what has been described above until the end of the video segment 504.

1. A method of generating a composite video stream from a plurality of video segments which overlap in time, each segment being identified by a capture time interval and each segment having a priority level comprising:
obtaining a primary video segment comprising a sequence of intra-coded I frames and predicted P frames, the primary video segment having a first priority level and a first capture time interval;
identifying a secondary video segment having a second priority level higher than the first priority level and a second capture time interval which overlaps with the first capture time interval, wherein the secondary video segment comprises a sequence of intra-coded I frames and predicted P frames;
time-aligning the primary and the secondary video segments by associating timelines of the two video segments;
identifying, using the associated timelines, a start merge time in the primary video segment of a first anchor I frame of the secondary video segment; and
merging frames of the primary video segment and frames of the secondary video segment, without transcoding, to generate a composite video, wherein the composite video comprises frames of the primary video segment up to the start merge time, the first anchor I frame and frames of the secondary video segment subsequent to the first anchor I frame.

2. The method of claim 1, wherein the video segments are encoded with different qualities, and a higher priority level indicates a higher quality.

3. The method of claim 2, wherein a higher quality video segment has a lower compression level than a lower quality video segment.

4. The method of claim 1, wherein the video segments are stored on a storage medium, and wherein the method comprises determining when a plurality of video segments on the storage medium overlap in time, and, for the overlapping time period, selecting the video segment having the highest priority level to form the composite video stream.

5. The method of claim 1, wherein the storage medium is a recording server and wherein the video segments are captured by video surveillance cameras and transmitted to the recording server.

6. The method of claim 1, further comprising:
identifying, using the associated timelines, an end merge time in the secondary video of a second anchor I frame of the primary video;
wherein the composite video comprises frames of the secondary video subsequent to the first anchor I frame up to the end merge time, the second anchor I frame and frames of the primary video subsequent to the second anchor I frame.

7. The method of claim 6, wherein the first anchor I frame of the secondary video is the first I frame in the secondary video sequence.

8. The method of claim 7, wherein the second anchor I frame is the last I frame in the primary video sequence prior to the time of the last frame of the secondary video sequence.

9. The method of claim 1, wherein the secondary video has a higher spatial resolution than the primary video.

10. Apparatus for generating a composite video stream from a plurality of video segments which overlap in time, each segment being identified by a capture time interval and each segment having a priority level comprising:
a processor configured to:
obtain a primary video segment comprising a sequence of intra-coded I frames and predicted P frames, the primary video segment having a first priority level and a first capture time interval;
identify a secondary video segment having a second priority level higher than the first priority level and a second capture time interval which overlaps with the first capture time interval, wherein the secondary video segment comprises a sequence of intra-coded I frames and predicted P frames;
time-align the primary and the secondary video segments by associating timelines of the two video segments;
identify, using the associated timelines, a start merge time in the primary video segment of a first anchor I frame of the secondary video segment; and
merge frames of the primary video segment and frames of the secondary video segment, without transcoding, to generate a composite video, wherein the composite video comprises frames of the primary video segment up to the start merge time, the first anchor I frame and frames of the secondary video segment subsequent to the first anchor I frame.

11. The apparatus of claim 10, wherein the video segments are encoded with different qualities, and a higher priority level indicates a higher quality.

12. The apparatus of claim 10, wherein a higher quality video segment has a lower compression level than a lower quality video segment.

13. The apparatus of claim 10, wherein the video segments are stored on a storage medium, and wherein the apparatus comprises means to determine when a plurality of video segments on the storage medium overlap in time, and, for the overlapping time period, selecting the video segment having the highest priority level to form the composite video stream.

14. The apparatus of claim 10, wherein the storage medium is a recording server and wherein the video segments are captured by video surveillance cameras and transmitted to the recording server.

15. A computer program which, when executed by a programmable apparatus, causes the apparatus to perform a method of generating a composite video stream from a plurality of video segments which overlap in time, each segment being identified by a capture time interval and each segment having a priority level comprising:
obtaining a primary video segment comprising a sequence of intra-coded I frames and predicted P frames, the primary video segment having a first priority level and a first capture time interval;
identifying a secondary video segment having a second priority level higher than the first priority level and a second capture time interval which overlaps with the first capture time interval, wherein the secondary video segment comprises a sequence of intra-coded I frames and predicted P frames;
time-aligning the primary and the secondary video segments by associating timelines of the two video segments;
identifying, using the associated timelines, a start merge time in the primary video segment of a first anchor I frame of the secondary video segment; and
merging frames of the primary video segment and frames of the secondary video segment, without transcoding, to generate a composite video, wherein the composite video comprises frames of the primary video segment up to the start merge time, the first anchor I frame and frames of the secondary video segment subsequent to the first anchor I frame.
